(19) United States
(12) Patent Application Publication
(10) Pub. No.: US 2014/0097375 A1
(43) Pub. Date: Apr. 10, 2014

(54) POLYMER AND APPLICATIONS THEREOF

(71) Applicant: NATIONAL TAIWAN UNIVERSITY, Taipei City (TW)

(72) Inventors: KUO-CHUNG HO, Taipei City (TW); Jiang-Jen Lin, Taipei City (TW); Rui-Xuan Dong, Taipei City (TW); Chung-Te Liu, Taipei City (TW); Sheng-Yen Shen, Taipei City (TW); Hsin-Wei Chen, Taipei City (TW); Po-Ta Shih, Taipei City (TW)

(73) Assignee: National Taiwan University, Taipei City (TW)

(21) Appl. No.: 13/859,218

(22) Filed: Apr. 9, 2013

(30) Foreign Application Priority Data
Oct. 8, 2012 (TW) 101137172

(51) Int. Cl. C08G 69/40; H01G 9/20; B01D 15/00

(52) U.S. Cl. CPC C08G 69/40; B01D 15/00; H01G 9/2004
USPC 252/62.2; 528/322; 528/229; 528/321; 210/660; 210/690

(57) ABSTRACT

The present disclosure is directed to an elastic polymer having characteristics of swelling by absorbing liquid and, and applications of preparation of gel electrolyte and absorbing the liquid by the polymer. The polymer is obtained by binding a poly(oxyethlene) L-NHₘ with a compound R being one elected from the group consisting of an acid, an anhydride and a combination thereof.

### CROSS-REFERENCE TO RELATED APPLICATION AND CLAIM OF PRIORITY

The application claims the benefit of Taiwan Patent Application No. 101137172, filed on Oct. 8, 2012, in the Taiwan Intellectual Property Office, the disclosures of which are incorporated herein in their entirety by reference.

### TECHNICAL FIELD

The present disclosure is directed to a polymer having characteristics of swelling by absorbing liquid and elasticity, and applications of preparation of gel electrolyte and absorbing the liquid by the polymer. Specifically, the polymer is obtained by binding a poly(oxyethlene) L-NHₘ with a compound R being one elected from the group consisting of an acid, an anhydride and a combination thereof.

### BACKGROUND

The dye-sensitized solar cell (DSSC) was invented by the team leaded by Swiss scientist, M. Grätzel, in 1991 and belongs to a new generation of solar cell. DSSC is mainly composed of three parts which are the nanocrystalline TiO₂ photoelectrode adsorbing the dye, the counter electrode and the redox electrolyte. Generally, the liquid organic system of I⁻/I⁻₃ redox is used for the electrolyte. So far, the DSSC using the liquid electrolyte has the highest photoelectric conversion efficiency of 12.38% as having been recorded in the references. However, the researchers find that the main reason for the limited operating life of DSSC is because the liquid electrolyte used in the DSSC contains the liquid organic solvent which is highly volatile so that, under the high temperature and irradiation from sun for a long period, the solvent will vaporize and then exude from pores of the packaging materials of DSSC and therefore the concentration of solutes in the liquid electrolyte will change, which even makes the DSSC ineffective. Accordingly, it is very important to develop the semi-solid-state or quasi-solid-state electrolyte since such electrolytes can be applied to the DSSC to avoid the leakage of the electrolyte among the flexible elements and to enhance long-term stability of the whole system, e.g. DSSC. Many scholars are working on the development of semi-solid electrolyte to solve the problems of leakage and volatilization of the liquid electrolyte. Since the room-temperature ionic liquid and polymer gel electrolyte have many advantages, such as having characteristics of no vapor pressure, non-flammability, high thermal stability, wide electro-chemical window and high ionic conductivity, they have considerable potential to replace the organic solvent in the liquid electrolyte. In addition, if the electrolyte continuously exists in a flowing state under a wide range of temperature, the electrolyte is convenient for the injection into the DSSC and the filling of internal structure of porous dye-sensitized titanium dioxide electrode.

In recent years, considerable research teams develop the polymer gel electrolyte (as shown in Table 1) in which the polymers usually have weight content of 20% and the other components are organic solvents so that the solvent easily leads and the stability of the cells is decreased. Besides, all the defects of non-perfect soak of the electrolyte for the porous TiO2 film, bad contact of the electrolyte with the counter electrode and insufficient absorption of the electrolyte for the polymer will cause the poor efficiency (<6%) for the DSSC. If a polymer gel electrolyte being able to avoid the leakage and volatilization of the electrolyte liquid and maintain a high conductivity is provided, the opportunity for the application of DSSC must be increased.

TABLE 1

| Polymer type | Efficiency (η, %) |
|---|---|
| Poly(acrylic acid-g-gelatin)/polypyrrole | 1.28 (100 mW cm⁻²) |
| Poly(glycidyl acrylate)/polypyrrole (PGA/PPy) | 5.03 (100 mW cm⁻²) |
| Crown ether/silica nanoparticles | 3.60 (100 mW cm⁻²) |
| Poly(acrylic acid)-oligo-(ethylene glycol) | 4.74 (100 mW cm⁻²) |
| Poly(acrylamide)/poly(ethylene glycol) | 3.00 (60 mW cm⁻²) |
| Ureasil/Sulfolane | 5.00 (100 mW cm⁻²) |
| P(MMA-co-MMA)/PEG | 4.85 (100 mW cm⁻²) |
| Poly(acrylic acid)/Poly(ethylene glycol) | 6.10 (100 mW cm⁻²) |
| (PAA/PEG) | |
| Poly(ether urethane)/Poly(ethylene oxide)/SiO₂ | 3.71 (100 mW cm⁻²) |

Employing experiments and researches full-heartily and persistently, the applicant finally conceived the method for adjusting brightness and system thereof.

### SUMMARY

The present disclosure is directed to an elastic polymer having characteristic of swelling by absorbing liquid, and applications of preparation of gel electrolyte and absorbing the liquid by the polymer.

On another aspect, the present disclosure provides an elastic polymer comprising a poly(oxyethlene) L-NHₘ having an amine terminal group NHₘ, wherein N is a nitrogen, H is a hydrogen and in is 1 or 2, and a compound R bound with the amine terminal group and being one selected from the group consisting of a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

On another aspect, the present disclosure provides A method for preparing a gel electrolyte, comprising the steps of: providing a polymer comprising a poly(oxyethlene) L-NHₘ having an amine terminal group NHₘ and a compound R bound with the amine terminal group, wherein N is a nitrogen, H is a hydrogen, m is 1 or 2 and the compound R is one selected from the group consisting of an acid, an anhydride and a combination thereof; providing a liquid electrolyte; and absorbing the liquid electrolyte by the polymer.

On another aspect, the present disclosure provides A method for absorbing a liquid, comprising the steps of providing a polymer comprising a poly(oxyethlene) L-NHₘ having an amine group NHₘ and a compound R bound with the amine group, wherein N is a nitrogen, H is a hydrogen, m is 1 or 2 and the compound R is one selected from the group consisting of an acid, an anhydride and a combination thereof; providing the liquid; and mixing the liquid with the polymer.

### BRIEF DESCRIPTION OF THE DRAWINGS

FIG. 1 is a diagram showing the photoelectric characteristics of the present gel electrolyte.

### DETAILED DESCRIPTION

The present disclosure can be fully understood and accomplish by the skilled person according to the following embodiments. However, the practice of the present method is not limited into following embodiments.

The present disclosure is directed to an elastic polymer made by materials of a poly(oxyethlene) L-NHₘ having an amine group NHₘ and a compound R. In one embodiment, the amine group NHₘ is a terminal group of the poly(oxyethlene), N is a nitrogen, H is a hydrogen, m is 1 or 2, and the compound R is bound with the amine terminal group and is an acid, an anhydride or a combination thereof. Specifically, the compound R may be a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride or a combination thereof. The poly(oxyethlene) has a molecular weight ranged between 200 and 10,000. The elastic polymer has a formula of L-HN—R—NH-L, H₂N—R—NH-L, H₂N—R—NH-L, H₂N—R—NH-L-NH—R—NH₂, L-(HN—R—NH-L)ₓ, H₂N—R—NH-(L-HN—R—NH)ₓ—H or a combination thereof, and x is an integer ranged between 1 and 25. In one embodiment, the elastic polymer is a copolymer.

The preparation of the present elastic polymer is introduced as follows.

### EMBODIMENT A

The main reacting materials of Embodiment A are shown as follows. The poly(oxyethlene) is the Jeffamine ED-2001 of Jeffamine® Amines (poly(oxypropylene-oxyethylene-oxypropylene)-bis-amines) which is a poly(oxypropylene)-diamine, appears as a hydrophilic white waxy solid, and has the molecular weight of 2000 (and so called POE2000), the melting point (mp.) of 35° C., the amine content of 0.95 mequiv./g, the average of oxyethylene/oxypropylene unit of 39.5/5 and the structure of

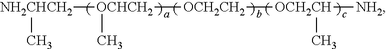

wherein a+c=6 and b=39. The compound R is the pyromellitic dianhydride (PMDA) bought from Aldrich Chemical Co. or Sino-Japan chemical Co.. The pyromellitic dianhydride is purified by sublimation before used and has the structure of

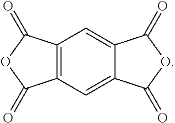 [SMILES: O=c1oc(=O)c2cc3c(=O)oc(=O)c3cc12]

The final product of Embodiment A is produced as follows. Firstly, POE2000 is purified by sublimation. Next, the POE2000 (10 g, 0.005 mol) is dissolved in tetrahydrofuran (THF) (10 mL and has been dewatered by calcium hydride) in a three-necked flask and then PMDA (0.92 g, 0.0042 mol, and dissolved in 5 mL of THF) is added into the mixture of the POE2000 and THF drop by drop until the POE2000 and the PMDA have a molar ratio of 6:5. Those reacting materials are mechanically stirred and reacted for three hours or more under an environment having the temperature lower than 150° C. and filled with nitrogen through the reacting period. The reaction of those reacting materials are monitored by Fourier Transform Infrared spectroscopy (FT-IR). Specifically, the reaction product is sampled from time to time and observed by FT-IR until the peak of the amide functional group of the product is reduced and the imide functional group of the product is generated and no further increased to obtain the final product. The final product is a light yellow sticky solid and is the poly(oxyethylene)-segmented amide-imide. This final product will naturally cross-link and transform into an elastomer when stands for more then one day under the temperature between 0° C. and 200° C.

### EMBODIMENT B

The main reacting materials of Embodiment B are shown as follows. The poly(oxyethlene) is the Jeffamine D-2000 of Jeffamine® Amines (poly(oxypropylene-oxyethylene)-bis-amines) which is a poly(oxypropylene)-monoamine and hydrophpbic, and has the molecular weight of 2000 (and so called POP2000) and the structure of

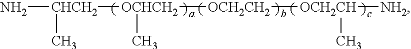

wherein a+c=33 and b=0.

The preparation of the final product of Embodiment B is identical to that of Embodiment A except the POE2000 is substituted by the POP2000. The final product of Embodiment B will naturally cross-link and transform into an elastomer when stands for more then about one day under the temperature between 0° C. and 200° C.

The respective reaction formulas of final products of Embodiments A and B are shown as follows.

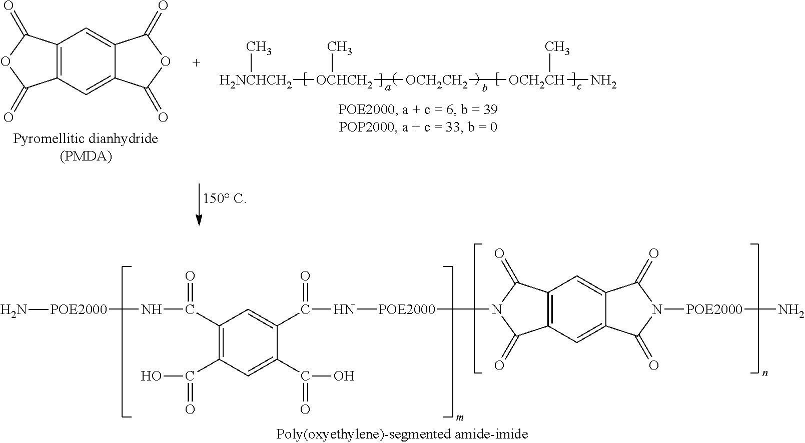

EMBODIMENT C

The preparation of the final product of Embodiment C is identical to those of Embodiments A and B except the PMDA is substituted by the 3,3′,4,4′-biphenyl tetracarboxylic dianhydride (s-BPDA). The final product of Embodiment C will naturally cross-link and transform into an elastomer when stands for more then about one day under the temperature between 0° C. and 200° C.

The reaction formula of final product of Embodiment C is shown as follows.

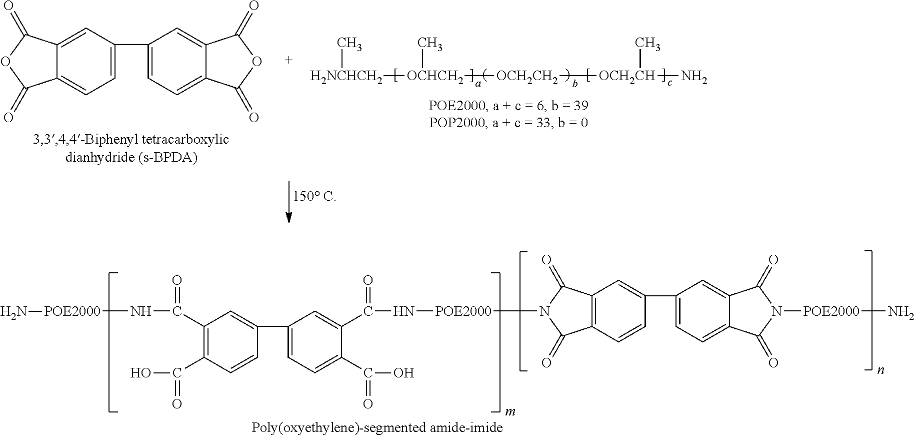

EMBODIMENT D

The preparation of the final product of Embodiment D is identical to those of Embodiments A and B except the PMDA is substituted by the 4,4′-(hexafluoroisopropylidene)diphthalic anhydride (6FDA). The final product of Embodiment D will naturally cross-link and transform into an elastomer when stands for more then about one day under the temperature between 0° C. and 200° C.

The reaction formula of final product of Embodiment D is shown as follows.

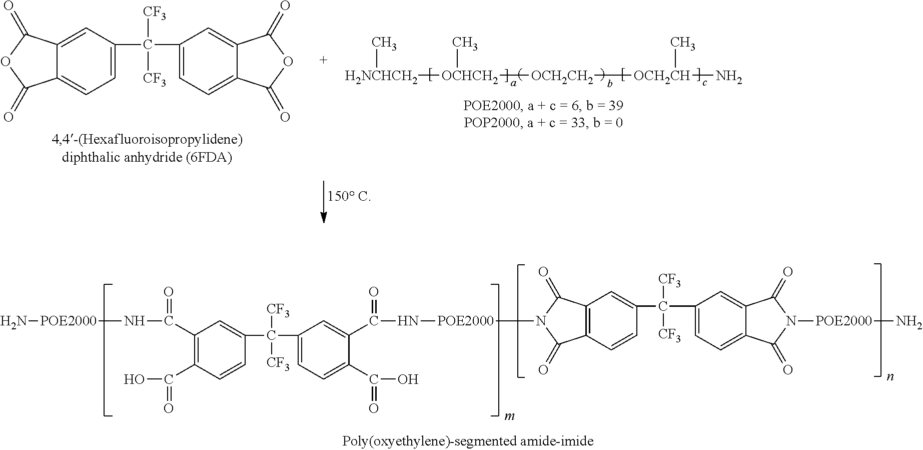

EMBODIMENT E

The preparation of the final product of Embodiment E is identical to those of Embodiments A and B except the PMDA is substituted by the 3,3′,4,4′-benzophenone tetracarboxylic dianhydride (BTDA). The final product of Embodiment E will naturally cross-link and transform into an elastomer when stands for more then about one day under the temperature between 0° C. and 200° C.

The reaction formula of final product of Embodiment E is shown as follows.

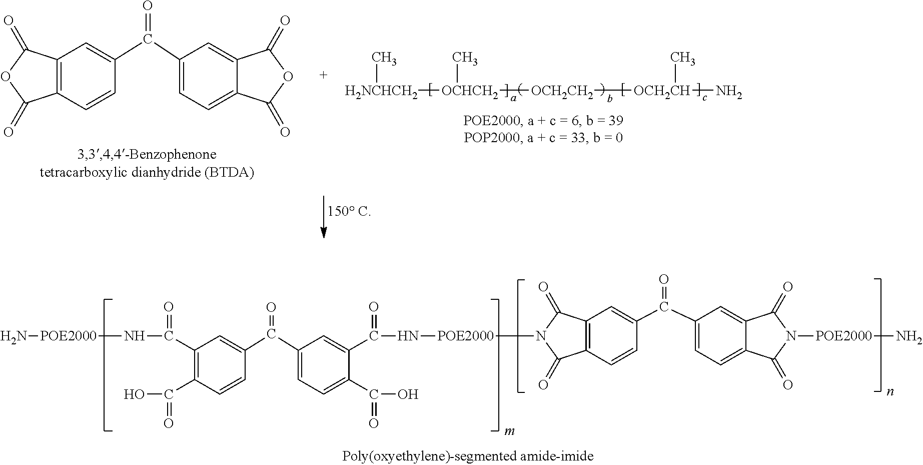

EMBODIMENT F

The preparation of the final product of Embodiment F is identical to those of Embodiments A and B except the PMDA is substituted by the trimellitic anhydride (TMA). The final product of Embodiment F will naturally cross-link and transform into an elastomer when stands for more then about one day under the temperature between 0° C. and 200° C.

The reaction formula of final product of Embodiment F is shown as follows.

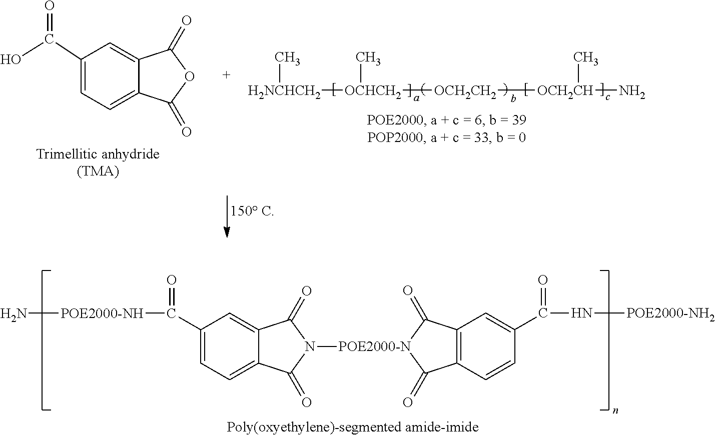

### EMBODIMENT G

The preparation of the final product of Embodiment G is identical to those of Embodiments A and B except the PMDA is substituted by the 3,3′,4,4′-diphenylsulfonetetracarboxylic dianhydride (DSDA). The final product of Embodiment F will naturally cross-link and transform into an elastomer when stands for more then about one day under the temperature between 0° C. and 200° C.

The reaction formula of final product of Embodiment G is shown as follows.

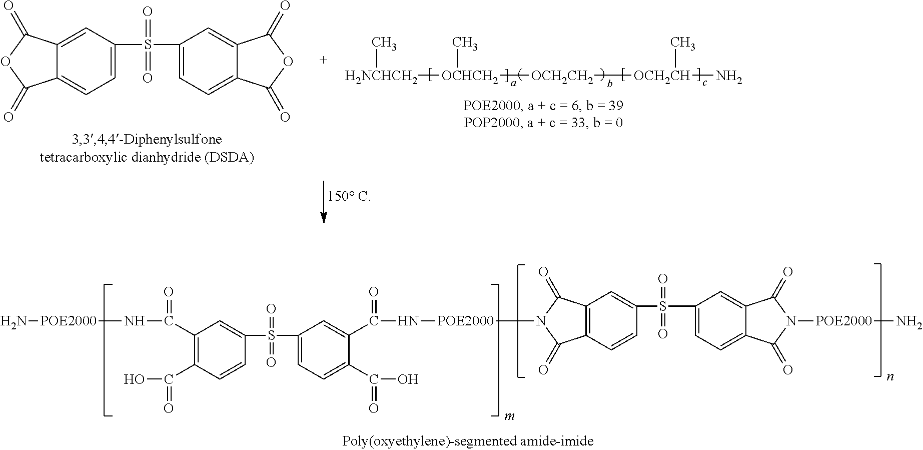

The reacting temperature and time for producing the present elastic polymer are ranged between 25° C. and 150° C. and 1 to 12 hours respectively. The poly(oxyethlene) L-NHₘ and the compound R have a molar radio of (n+1):n or n:(n+1), and n is an integer ranged between 1 and 25. Those provided reaction conditions are adjustable depending on the reactants or other needs.

Since POE2000 and POP2000 are hydrophilic and hydrophobic poly(oxyethlene)s respectively, and therefore, under the condition of using the same compound R, the respective backbones of polyoxyethylene-amides (i.e. the final products) made by above-mentioned preparations are correspondingly changed so as to cause the final products become the hydrophilic or hydrophobic polymer. For example, since both the compounds R used in the Embodiments A and B are PMDA, and POE2000 and POP2000 are hydrophilic and hydrophobic respectively, so that the final products of Embodiments A and B are hydrophilic and hydrophobic polymers respectively.

The present disclosure is also directed to a polymer being able to absorb a liquid and made by materials of a poly(oxyethlene) L-NHₘ having an amine group NHₘ and a compound R. In one embodiment, the amine group NHₘ is a terminal group of the poly(oxyethlene), N is a nitrogen, H is a hydrogen, m is 1 or 2, and the compound R is bound with the amine terminal group and is an acid, an anhydride or a combination thereof. Specifically, the compound R may be a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride or a combination thereof. The poly(oxyethlene) has a molecular weight ranged between 200 and 10,000. The elastic polymer has a formula of L-HN—R—NH-L, H₂N—R—NH-L, R—NH-L, H₂N—R—NH-L-NH—R—NH₂, H₂N—R—NH-(L-HN—R—NH)ₓ—H or a combination thereof, and x is an integer ranged between 1 and 25.

Based on the above descriptions regarding the present polymer being able to absorb the liquid, all the final products of Embodiments A to G are the present polymer being able to absorb the liquid.

As observed by the results of experiments, the present polymer is insoluble either in water or organic solvent, has the characteristic of swelling and may absorb large amounts of liquid (such as solvents of water, organic one or the combination thereof) time-dependently. The polymer containing the absorbed liquid will become a colloidal polymer and still have the characteristic of elasticity. In one embodiment, when the final polymer of Embodiment A is soaked in 3-methoxypropionitrile (MPN), the final polymer absorbs three times of its weight of MPN after one hour and absorbs eleven times of its weight of MPN after one day. The organic solvent absorbed by the present polymer may be, for example, methanol, ethanol, isopropanol (IPA), acetone, ethylene carbonate (EC), propylene carbonate (PC), gamma-butyrolactone ester (GBL), methyl nitrile, THF, methyl ethyl ketone (MEK), MPN and N-methyl-2-pyrrolidone (NMP) or a combination thereof.

In addition, as mentioned above, since the present polymer can be made by hydrophilic or hydrophobic poly(oxyethlene) or the combination thereof, the polymer will therefore becomes hydrophobic, hydrophilic or amphiphilic correspondingly. Accordingly, the present polymer is applicable to mainly absorb the water, organic solvent or both.

Via the polymer being able to absorb the liquid, a gel electrolyte and the preparing method thereof are provided. In one embodiment, the present polymer is soaked in a liquid electrolyte, then the liquid electrolyte is absorbed into the polymer so as to form the gel electrolyte. When the present polymer absorbs the liquid, e.g. liquid electrolyte, the reaction temperature has range of −20° C. to 80° C. and the absorption time is 1 second to 7 days. Besides, the liquid and the polymer in the liquid-absorbed polymer have a radio by weight ranged from 99:1 to 1:99.

The liquid electrolyte absorbed by the present polymer, for example, is composed of 1,2-dimethyl-3-propylimidazolium iodide (DMPII, 6M), LiI (0.1M), I₂ (0.05M) and 4-tert-butylpyridine (TBP, 0.5M, 96%) dissolved in MPN (99%), NaI and I₂ dissolved in co-solvent of EC, PC and acetonitrile, LiI, I₂ and DMPII dissolved in co-solvent of EC and GBL, KI and I₂ dissolved in acetonitrile, NaI, I₂ and TBP dissolved in acetonitrile, or Al₂O₃, LiI, I₂ and TBP dissolved in co-solvent of EC and PC.

In one embodiment, the final product of polymer of Embodiment A is soaked in the liquid electrolyte composed of DMPII (6M), LiI (0.1M), I₂ (0.05M) and TBP (0.5M) dissolved in MPN, and then the polymer starts to absorb the liquid electrolyte and therefore to be formed as a gel electrolyte. With the increase of time, the concentration of the electrolyte or the electrolyte liquid in the gel electrolyte becomes higher until arriving the saturation after about 24 hours. When the electrolyte liquid is saturated in the gel electrolyte, the respective weights of the final product of Embodiment A and the liquid electrolyte of the gel electrolyte are 91.6% and 8.4%.

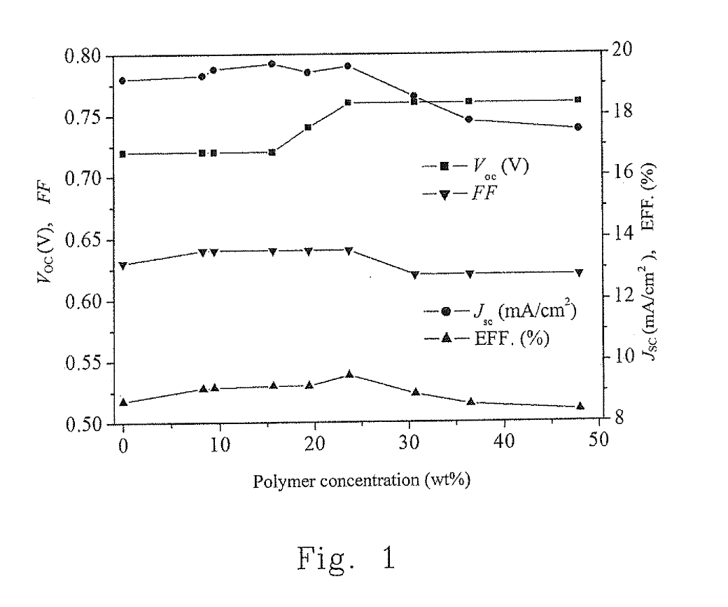

In one embodiment, the above gel electrolyte is applied to DSSC and performs a better power-conversion efficiency (EFF., η). Specifically, the gel electrolytes 1, 2 and 3 containing various contents of liquid electrolyte (composed of DMPII (6M), LiI (0.1M), I₂ (0.05M) and TBP (0.5M) dissolved in MPN) are made by soaking the final product of Embodiment A in the liquid electrolyte for 10 minutes, 1 hour and 24 hours respectively. Each of the gel electrolytes 1, 2 and 3, the counter electrode splashed by rhodium particles and the working electrode made by TiO₂ dispersed by polyethylene glycol) (PEG) are assembled to be configured as a testing element. Subsequently, those testing elements containing therein the gel electrolytes 1, 2 and 3 (Gels 1, 2 and 3) are illuminated by light (100 mW cm⁻²) and the respective conductivities (σ), open circuit voltages (V_{oc}), short-circuit current densities (J_{SC}), filling factors (FF) and power-conversion efficiencies thereof are measured. A testing element assembled by the counter and working electrodes identical to those of above testing elements and containing the liquid electrolyte only is configured and those photoelectric properties are measured for the reference. All the measured values are shown in Table 2 and FIG. 1, and each of measured values is an average value obtained by four independent measurements.

TABLE 2

| | Conc. of | | | | | |
|---|---|---|---|---|---|---|
| | polymer | σ/10³ | V_{oc} | J_{sc} | | η |
| Electrolyte | (wt %) | (mS/cm) | (V) | (mA/cm²) | FF | (%) |
| Liquid | 0 | 12.75 ± 0.31 | 0.72 ± 0.01 | 19.03 ± 0.13 | 0.63 ± 0.01 | 8.53 ± 0.13 |
| Gel 1 | 49.38 ± 1.26 | 11.77 ± 0.16 | 0.77 ± 0.01 | 17.72 ± 0.18 | 0.62 ± 0.01 | 8.35 ± 0.08 |
| Gel 2 | 23.15 ± 0.49 | 12.77 ± 0.11 | 0.76 ± 0.01 | 19.60 ± 0.05 | 0.64 ± 0.01 | 9.50 ± 0.03 |
| Gel 3 | 8.60 ± 0.22 | 12.55 ± 0.06 | 0.73 ± 0.01 | 19.20 ± 0.20 | 0.64 ± 0.01 | 8.98 ± 0.09 |

As shown in Table 2, the power-conversion efficiencies generated by gel electrolytes 2 and 3 are higher than that of liquid electrolyte of 8.53%. Also, the open circuit voltages and the short-circuit current densities generated by gel electrolytes 2 and 3 are higher than those of liquid electrolyte.

In summary, the present disclosure does provide an elastic polymer with characteristic of swelling and being of to absorb large amounts of water or an organic solvent. With the mentioned features, the present polymer can absorb the liquid electrolyte to transform into a polymer gel electrolyte and to be applied to DSSC. The DSSC using the present polymer gel electrolyte indeed has better photoelectric properties than that using the liquid electrolyte. Therefore, the present polymer gel electrolyte can substitute the liquid electrolyte used in DSSC so as to solve the defects of easy leakage and volatilization caused by the liquid electrolyte.

### EMBODIMENTS

Embodiment 1: An elastic polymer, comprising: a poly(oxyethlene) L-NHₘ having an amine terminal group NHₘ, wherein N is a nitrogen, H is a hydrogen and m is 1 or 2; and a compound R bound with the amine terminal group and being one selected from the group consisting of a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

Embodiment 2 is the elastic polymer as described in Embodiment 1 and has a formula being one selected from the group consisting of an L-HN—R—NH-L, an H₂N—R—NH-L, an H₂N—R—NH-L, an H₂N—R—NH-L-NH—R—NH₂, an L-(HN—R—NH-L)ₓ, an H₂N—R—NH-(L-HN—R—NH)ₓ—H and a combination thereof, wherein x is an integer ranged between 1 and 25.

Embodiment 3 is the elastic polymer as described in Embodiment 1 being a copolymer.

Embodiment 4: A method for preparing a gel electrolyte, comprising the steps of: providing a polymer comprising a poly(oxyethlene) L-NHₘ having an amine terminal group NHₘ and a compound R bound with the amine terminal group, wherein N is a nitrogen, H is a hydrogen, m is 1 or 2 and the compound R is one elected from the group consisting of an acid, an anhydride and a combination thereof; providing a liquid electrolyte; and absorbing the liquid electrolyte by the polymer.

Embodiment 5 is the method as described in Embodiment 4 further comprising a step of mixing the liquid electrolyte with the polymer so as to cause the liquid electrolyte to be absorbed by the polymer.

Embodiment 6 is the method as described in Embodiment 4, wherein the compound R is one selected from the group consisting of a pyromellitic dianhydride, a 3,3′,4,4′1-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

Embodiment 7 is the method as described in Embodiment 4, wherein the polymer has a formula being one selected from the group consisting of an L-HN—R—NH-L, an H₂N—R—NH-L, an H₂N—R—NH-L, an H₂N—R—NH-L-NH—R—NH₂, an L-(HN—R—NH-L)ₓ, an H₂N—R—NH-(L-HN—R—NH)ₓ—H and a combination thereof, and x is an integer ranged between 1 and 25.

Embodiment 8 is the method as described in Embodiment 4, wherein the step of absorbing the liquid electrolyte by the polymer has a reacting period between one second and seven days.

Embodiment 9 is the method as described in Embodiment 4, wherein the step of absorbing the liquid electrolyte by the polymer has a reacting temperature between −20° C. and 80° C.

Embodiment 10 is the method as described in Embodiment 4, wherein the liquid electrolyte and the polymer in the gel electrolyte have a radio by weight ranged from 99:1 to 1:99.

Embodiment 11 is the method as described in Embodiment 4, wherein the poly(oxyethlene) L-NHₘ is one selected from the group consisting of a hydrophobic material, a hydrophilic material and a combination thereof so as to cause the polymer to be hydrophobic, hydrophilic or amphiphilic correspondingly.

Embodiment 12: A method for absorbing a liquid, comprising the steps of: providing a polymer comprising a poly(oxyethlene) L-NHₘ having an amine group NHₘ and a compound R bound with the amine group, wherein N is a nitrogen, H is a hydrogen, m is 1 or 2 and the compound R is one elected from the group consisting of an acid, an anhydride and a combination thereof; providing the liquid; and mixing the liquid with the polymer.

Embodiment 13 is the method as described in Embodiment 12, wherein the liquid is a solvent being one selected from the group consisting of a water, an organic solvent and a combination thereof.

Embodiment 14 is the method as described in Embodiment 12, wherein the liquid is an liquid electrolyte.

Embodiment 15 is the method as described in Embodiment 12, wherein the poly(oxyethlene) L-NHₘ is one selected from the group consisting of a hydrophobic material, a hydrophilic material and a combination thereof so as to cause the polymer to be hydrophobic, hydrophilic or amphiphilic correspondingly.

Embodiment 16 is the method as described in Embodiment 12 and further comprises a step of obtaining the polymer by oligomerizing the poly(oxyethlene) L-NHₘ and the compound R, wherein the compound R is one selected from the group consisting of a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

Embodiment 17 is the method as described in Embodiment 16, wherein the poly(oxyethlene) L-NHₘ and the compound R have a molar radio of (n+1):n or n:(n+1), and n is an integer ranged between 1 and 25.

Embodiment 18 is the method as described in Embodiment 16, wherein the step of obtaining the polymer has a reacting period between one hour and twelve hours.

Embodiment 19 is the method as described in Embodiment 16, wherein the step of obtaining the polymer has a reacting temperature between 0° C. and 200° C.

Embodiment 20 is the method as described in Embodiment 12, wherein the amine group NHₘ is a terminal group of the poly(oxyethlene) L-NHₘ.

While the disclosure has been described in terms of what is presently considered to be the most practical and preferred embodiments, it is to be understood that the disclosure needs not be limited to the disclosed embodiments. Therefore, it is intended to cover various modifications and similar arrangements included within the spirit and scope of the appended claims, which are to be accorded with the broadest interpretation so as to encompass all such modifications and similar structures.

What is claimed is:

1. An elastic polymer, comprising:
a poly(oxyethlene) L-NHₘ having an amine terminal group NHₘ, wherein N is a nitrogen, H is a hydrogen and m is 1 or 2; and
a compound R bound with the amine terminal group and being one selected from the group consisting of a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

2. The elastic polymer as claimed in claim 1 having a formula being one selected from the group consisting of an L-HN—R—NH-L, an H₂N—R—NH-L, an H₂N—R—NH-L, an H₂N—R—NH-L-NH—R—NH₂, an L-(HN—R—NH-L)ₓ, an H₂N—R—NH-(L-HN—R—NH)ₓ—H and a combination thereof, wherein x is an integer ranged between 1 and 25.

3. The elastic polymer as claimed in claim 1 being a copolymer.

4. A method for preparing a gel electrolyte, comprising the steps of:
providing a polymer comprising a poly(oxyethlene) L-NHₘ having an amine terminal group NHₘ and a compound R bound with the amine terminal group, wherein N is a nitrogen, H is a hydrogen, m is 1 or 2 and the compound R is one elected from the group consisting of an acid, an anhydride and a combination thereof;
providing a liquid electrolyte; and
absorbing the liquid electrolyte by the polymer.

5. The method as claimed in claim 4 further comprising a step of mixing the liquid electrolyte with the polymer so as to cause the liquid electrolyte to be absorbed by the polymer.

6. The method as claimed in claim 4, wherein the compound R is one selected from the group consisting of a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

7. The method as claimed in claim 4, wherein the polymer has a formula being one selected from the group consisting of an L-HN—R—NH-L, an H₂N—R—NH-L, an H₂N—R—NH-L, an H₂N—R—NH-L-NH—R—NH₂, an L-(HN—R—NH-L)ₓ, an H₂N—R—NH-(L-HN—R—NH)ₓ—H and a combination thereof, and x is an integer ranged between 1 and 25.

8. The method as claimed in claim 4, wherein the step of absorbing the liquid electrolyte by the polymer has a reacting period between one second and seven days.

9. The method as claimed in claim 4, wherein the step of absorbing the liquid electrolyte by the polymer has a reacting temperature between −20° C. and 80° C.

10. The method as claimed in claim 4, wherein the liquid electrolyte and the polymer in the gel electrolyte have a radio by weight ranged from 99:1 to 1:99.

11. The method as claimed in claim 4, wherein the poly(oxyethlene) L-NHₘ is one selected from the group consisting of a hydrophobic material, a hydrophilic material and a combination thereof so as to cause the polymer to be hydrophobic, hydrophilic or amphiphilic correspondingly.

12. A method for absorbing a liquid, comprising the steps of:
providing a polymer comprising a poly(oxyethlene) L-NHₘ having an amine group NHₘ and a compound R bound with the amine group, wherein N is a nitrogen, H is a hydrogen, m is 1 or 2 and the compound R is one elected from the group consisting of an acid, an anhydride and a combination thereof;
providing the liquid; and
mixing the liquid with the polymer.

13. The method as claimed in claim 12, wherein the liquid is a solvent being one selected from the group consisting of a water, an organic solvent and a combination thereof.

14. The method as claimed in claim 12, wherein the liquid is an liquid electrolyte.

15. The method as claimed in claim 12, wherein the poly(oxyethlene) L-NHₘ is one selected from the group consisting of a hydrophobic material, a hydrophilic material and a combination thereof so as to cause the polymer to be hydrophobic, hydrophilic or amphiphilic correspondingly.

16. The method as claimed in claim 12 further comprising a step of obtaining the polymer by oligomerizing the poly(oxyethlene) L-NHₘ and the compound R, wherein the compound R is one selected from the group consisting of a pyromellitic dianhydride, a 3,3′,4,4′-biphenyl tetracarboxylic dianhydride, a 4,4′-(hexafluoroisopropylidene)diphthalic anhydride, a 3,3′,4,4′-benzophenone tetracarboxylic dianhydride, a trimellitic anhydride, a 3,3′,4,4′-diphenylsulfonetetracarboxylic dianhydride, a maleic anhydride, a succinic anhydride, a phthalic anhydride, a tetrahydrophthalic anhydride and a combination thereof.

17. The method as claimed in claim 16, wherein the poly(oxyethlene) L-NHₘ and the compound R have a molar radio of (n+1):n or n:(n+1), and n is an integer ranged between 1 and 25.

18. The method as claimed in claim 16, wherein the step of obtaining the polymer has a reacting period between one hour and twelve hours.

19. The method as claimed in claim 16, wherein the step of obtaining the polymer has a reacting temperature between 0° C. and 200° C.

20. The method as claimed in claim 12, wherein the amine group NHₘ is a terminal group of the poly(oxyethlene) L-NHₘ.
